(19) United States
(12) Patent Application Publication
(10) Pub. No.: US 2006/0077586 A1
(43) Pub. Date: Apr. 13, 2006

(54) Spindle motor driving method and apparatus

(75) Inventors: Young Son, Yongin-si (KR); Cheol-soon Kim, Anyang-si (KR); Joo-young Kwak, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/245,199

(22) Filed: Oct. 7, 2005

(30) Foreign Application Priority Data
Oct. 13, 2004 (KR) 10-2004-0081773

(51) Int. Cl. G11B 15/46

(52) U.S. Cl. 360/73.03

(57) ABSTRACT

A spindle motor driving method and apparatus are provided. The method includes detecting the rotation speed of a spindle motor and heating a hard disc drive until the spindle motor reaches normal rotation speed. Accordingly, it is possible to enable the spindle motor to quickly reach the normal rotation speed by controlling the heating of the hard disc drive without using temperature and/or viscosity measurement sensors.

This application claims benefit from Korean Patent Application No. 10-2004-0081773, filed on Oct. 13, 2004, in the Korean Intellectual Property Office, the disclosure of which is incorporated herein in its entirety by reference.

### BACKGROUND OF THE INVENTION

1. Field of the Invention

The present invention relates to a hard disk drive, and more particularly, to a spindle motor driving method and apparatus, which can enable a spindle motor of a hard disk drive to quickly reach normal speed by heating the hard disk drive.

2. Description of the Related Art

Hard disc drives, which are generally used as auxiliary memory devices for computers, are apparatuses that record data on or reproduce data from a disc by moving a magnetic head over the surface of the disc while rotating the disc.

Fluid dynamic bearing-based spindle motors are more frequently used in such devices as hard disc drives which are required to have a large storage capacity and to achieve high rotational speed than ball bearing-based spindle motors because, when driven, fluid dynamic bearing-based spindle motors cause less friction and noise than ball bearing-based spindle motors and also have superior non-repeatable runout (NRRO) characteristics compared to ball bearing-based spindle motors. A fluid dynamic bearing is generally comprised of a rotation element, a fixed element, and an oil film therebetween. The fluid dynamic bearing supports the rotation element using pressure generated by the rotation force of the rotation element and thus can reduce friction load by separating the fixed element from the rotation element.

A hard disc drive using a fluid dynamic bearing operates normally at room temperatures (e.g., a temperature of 15-40° C.) causing few problems. However, the viscosity of a fluid increases at low temperatures (e.g., a temperature of 5° C.), and thus a spindle motor may not be able to reach normal rotation speed within a short period of time. Conventionally, in order to solve this problem, the hard disc drive is heated to lower the viscosity of the fluid, in which case, the spindle motor can easily achieve normal rotation speed within a short period of time.

In this type of technique, however, it is determined whether to heat the hard disc drive based on the temperature of the hard disc drive measured by temperature measurement sensors and the viscosity of the fluid measured by viscosity measurement sensors, and thus the hard disc drive needs to include such temperature and viscosity measurement sensors. Thus, the manufacturing costs of the hard disc drive increases.

### SUMMARY OF THE INVENTION

The present invention provides a spindle motor driving method which enables a spindle motor to quickly reach normal rotation speed by controlling the heating of a hard disc without using temperature and/or viscosity measurement sensors.

The present invention provides a spindle motor driving apparatus which enables a spindle motor to quickly reach normal rotation speed by controlling the heating of a hard disc without using temperature and/or viscosity measurement sensors.

According to an aspect of the present invention, there is provided a spindle motor driving method, the method comprising: detecting the rotation speed of a spindle motor; and heating a hard disc drive until the spindle motor reaches normal rotation speed.

According to another aspect of the present invention, there is provided a spindle motor driving apparatus, the apparatus comprising: a rotation speed detector, which detects the rotation speed of a spindle motor; and a heating controller, which controls the heating of a hard disc drive until the spindle motor reaches normal rotation speed.

### BRIEF DESCRIPTION OF THE DRAWINGS

The above aspects and other features and advantages of the present invention will become more apparent by describing in detail exemplary embodiments thereof with reference to the attached drawings in which:

FIG. 1 is a flowchart of a spindle motor driving method according to an exemplary embodiment of the present invention;

FIG. 2 is a detailed flowchart of an example of the heating operation of FIG. 1;

FIG. 3 is a graph illustrating the variation of the rotation speed of a spindle motor according to the passage of time;

FIG. 4 is a block diagram of a spindle motor driving apparatus according to an exemplary embodiment of the present invention; and

FIG. 5 is a detailed block diagram of an example of a heating controller of FIG. 4.

### DETAILED DESCRIPTION OF THE INVENTION

The present invention will now be described more fully with reference to the accompanying drawings in which exemplary embodiments of the invention are shown.

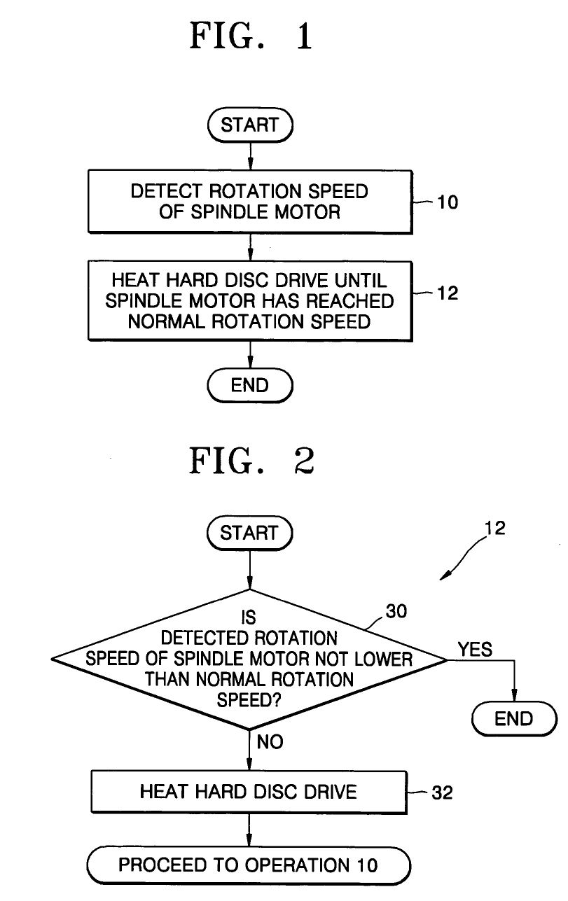

FIG. 1 is a flowchart of a spindle motor driving method according to an exemplary embodiment of the present invention. Referring to FIG. 1, in operation 10, the rotation speed of a spindle motor is detected. The rotation speed of the spindle motor may be detected by sensing a driving current supplied to a coil for driving the spindle motor.

Alternatively, the rotation speed of the spindle motor may be detected by sensing a back electromagnetic force (EMF) generated by the driving current. When the driving current is applied to the coil, an EMF is generated, and then the spindle motor begins rotating due to the EMF. The rotation of a permanent magnet installed in the spindle motor causes a back EMF to be generated, and the back EMF serves as resistance against the driving current. The back EMF is influenced by electromagnetic characteristics of the spindle motor and increases in proportion to the rotation speed of the spindle motor.

Still alternatively, the rotation speed of the spindle motor may be detected by measuring the phase of the spindle motor and then counting how many clock pulses are generated per unit rotation of the spindle motor. When the number of clock pulses per unit rotation of the spindle motor decreases, it is determined that the rotation speed of the spindle motor increases.

In operation 12, a hard disc drive is heated until the spindle motor reaches normal rotation speed. The normal rotation speed is a minimum rotation speed required for normally operating the hard disc drive.

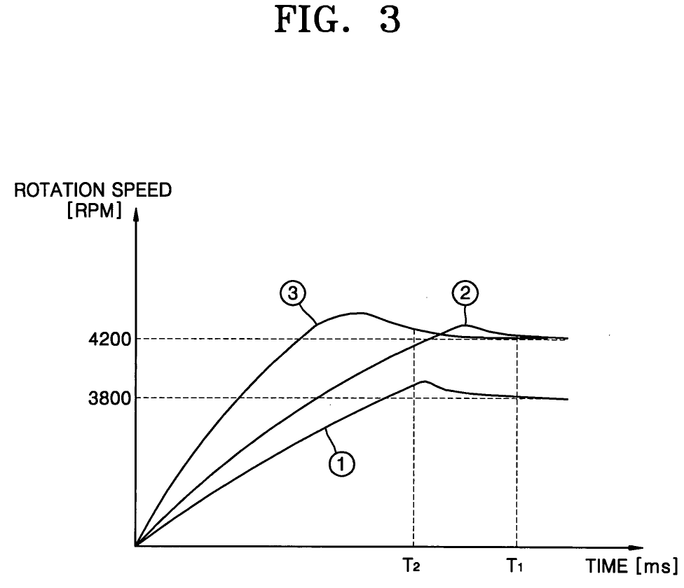

FIG. 2 is a detailed flowchart of an example of the heating operation 12 of FIG. 1. Referring to FIG. 2, in operation 30, it is determined whether detected rotation speed of a spindle motor is not lower than normal rotation speed. Specifically, only when the spindle motor has reached the normal rotation speed within a predetermined period of time, it is determined that the detected rotation speed of the spindle motor is not lower than the normal rotation speed.

FIG. 3 is a graph illustrating the variation of the rotation speed of a spindle motor according to the passage of time. Referring to FIG. 3, suppose that normal rotation speed is 4200 rpm or higher. In the case of \textcircled{1}, a spindle motor cannot reach the normal rotation speed no matter how much time has passed, and thus a hard disc drive cannot operate normally.

In the case of \textcircled{2}, the spindle motor can reach the normal rotation speed only after a considerable amount of time, i.e., T₁, has passed. Thus, the hard disc drive is not expected to be able to quickly perform its operations.

Generally, when the temperature of the hard disc drive is low, the viscosity of a fluid in a fluid dynamic bearing of the hard disc drive is high, and thus, the spindle motor is likely to abnormally rotate, as shown in the case of \textcircled{1} or \textcircled{2}.

In the case of \textcircled{3}, the spindle motor reaches the normal rotation speed after only a predetermined amount of time, i.e., T₂, has passed. The predetermined amount of time T₂ is a maximum amount of time within which the spindle motor is required to reach the normal rotation speed. Accordingly, since the spindle motor reaches the normal rotation speed within the predetermined amount of time T₂, the hard disc drive is expected to be able to quickly perform its operations. In short, as shown in the case of \textcircled{3}, the spindle motor should reach the normal rotation speed within the predetermined amount of time T₂ and maintain the normal rotation speed in order to make the hard disc drive operate normally.

If the spindle motor cannot reach the normal rotation speed within the predetermined amount of time T₂, as shown in the case of \textcircled{1} or \textcircled{2}, the viscosity of the fluid in the fluid dynamic bearing of the hard disc drive needs to be lowered by heating the hard disc drive.

Referring to FIG. 3, the gradient of \textcircled{1} or \textcircled{2} is smaller than the gradient of \textcircled{3}. Accordingly, if detected rotation speed of the spindle motor varies with a smaller gradient than the gradient of \textcircled{3} according to the passage of time, it is determined that the spindle motor has not yet reached the normal rotation speed. Otherwise, it is determined that the spindle motor has reached the normal rotation speed.

Referring to FIG. 2, in operation 32, if the detected rotation speed of the spindle motor is lower than the normal rotation speed, as shown in the case of \textcircled{1} or \textcircled{2} of FIG. 3, a hard disc drive is heated in order to lower the viscosity of a fluid in a fluid dynamic bearing of the hard disc drive, and then the spindle motor driving method returns to operation 30. Operations 30 and 32 are repeated until the detected rotation speed of the spindle motor is determined not to be lower than the normal rotation speed.

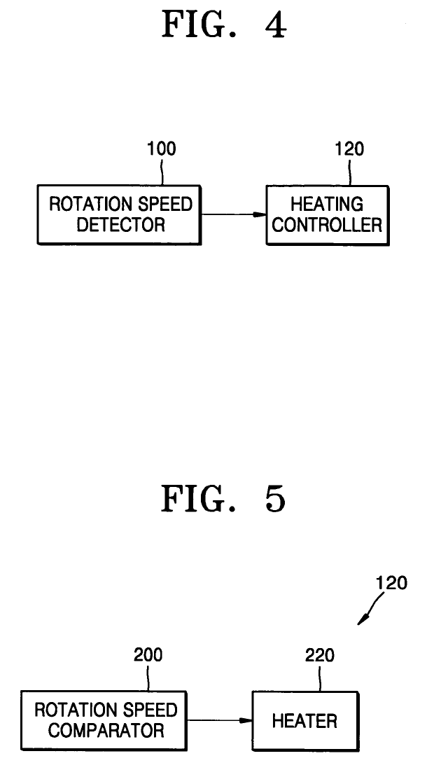

FIG. 4 is a block diagram of a spindle motor driving apparatus according to an exemplary embodiment of the present invention. Referring to FIG. 4, the spindle motor driving apparatus includes a rotation speed detector 100 and a heating controller 120.

The rotation speed detector 100 detects the rotation speed of a spindle motor and outputs the detection result to the heating controller 120.

Specifically, the rotation speed detector 100 may detect the rotation speed of the spindle motor by sensing a driving current supplied to a coil for driving the spindle motor.

Alternatively, the rotation speed detector 100 may detect the rotation speed of the spindle motor by sensing a back EMF generated by the driving current. The back EMF is influenced by electromagnetic characteristics of the spindle motor and increases in proportion to the rotation speed of the spindle motor.

Still alternatively, the rotation speed detector 100 may detect the rotation speed of the spindle motor by measuring the phase of the spindle motor and then counting how many clock pulses are generated per unit rotation of the spindle motor. When the number of clock pulses per unit rotation of the spindle motor decreases, the rotation speed detector 100 determines that the rotation speed of the spindle motor increases.

The heating controller 120 controls the heating of a hard disc drive until the detected rotation speed of the spindle motor reaches normal rotation speed.

FIG. 5 is a detailed block diagram of an example of the heating controller 120 of FIG. 4. Referring to FIG. 5, the heating controller 120 includes a rotation speed comparator 200 and a heater 220.

The rotation speed comparator 200 determines whether detected rotation speed of a spindle motor is not lower than normal rotation speed and outputs the determination results to the heater 220. The rotation speed comparator 200 determines that the detected rotation speed of the spindle motor is not lower than the normal rotation speed only when the spindle motor has reached the normal rotation speed within a predetermined amount of time.

Specifically, if the detected rotation speed of the spindle motor varies with a smaller gradient than the gradient of \textcircled{3} of FIG. 3 according to the passage of time, as shown in the case of \textcircled{1} or \textcircled{2} of FIG. 3, the rotation speed comparator 200 determines that the detected rotation speed of the spindle motor is lower the normal rotation speed. Otherwise, the rotation speed comparator 200 determines that the detected rotation speed of the spindle motor is not lower than the normal rotation speed.

The heater 220 determines whether to heat a hard disc drive based on the determination results provided by the rotation speed comparator 200.

Specifically, if the rotation speed comparator 200 determines that the detected rotation speed of the spindle motor is lower than the normal rotation speed, as shown in case of \textcircled{1} or \textcircled{2} of FIG. 3, the heater 220 heats the hard disc drive in order to lower the viscosity of a fluid in a fluid dynamic bearing of the hard disc drive.

As described above, the spindle motor driving method and apparatus according to exemplary embodiments of the present invention detect the rotation speed of a spindle motor without using temperature and/or viscosity measurement sensors. Thus, the spindle motor driving method and apparatus according to exemplary embodiments of the present invention can enable the spindle motor to quickly reach normal rotation speed by controlling the heating of a hard disc drive with reference to the detected rotation speed of the spindle motor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A spindle motor driving method comprising:
detecting a rotation speed of a spindle motor; and
heating a hard disc drive until the spindle motor reaches a normal rotation speed.

2. The spindle motor driving method of claim 1, wherein the rotation speed of the spindle motor is detected by sensing a driving current supplied for driving the spindle motor or a back electromagnetic force (EMF) of the driving current.

3. The spindle motor driving method of claim 1, wherein the rotation speed of the spindle motor is detected by counting a number of clock pulses generated per unit rotation of the spindle motor.

4. The spindle motor driving method of claim 1, wherein heating the hard disc drive comprises:
determining whether the detected rotation speed of the spindle motor is not lower than the normal rotation speed; and
heating the hard disc drive if the detected rotation speed of the spindle motor is lower than the normal rotation speed, and
then repeating the determination and the heating if the detected rotation speed of the spindle motor is lower than the normal rotation speed.

5. The spindle motor driving method of claim 4, wherein the detected rotation speed of the spindle motor is determined to be not lower than the normal rotation speed if the spindle motor is determined to have reached the normal rotation speed within a predetermined amount of time.

6. A spindle motor driving apparatus comprising:
a rotation speed detector, which detects a rotation speed of a spindle motor; and
a heating controller, which controls a heating of a hard disc drive until the spindle motor reaches a normal rotation speed.

7. The spindle motor driving apparatus of claim 6, wherein the rotation speed detector detects the rotation speed of the spindle motor by sensing a driving current supplied for driving the spindle motor or a back electromagnetic force (EMF) of the driving current.

8. The spindle motor driving apparatus of claim 6, wherein the rotation speed detector detects the rotation speed of the spindle motor by counting a number of clock pulses generated per unit rotation of the spindle motor.

9. The spindle motor driving apparatus of claim 6, wherein the heating controller comprises:
a rotation speed comparator, which determines whether the detected rotation speed of the spindle motor is not lower than the normal rotation speed; and
a heater, which determines whether to heat the hard disc drive based on the determination results provided by the rotation speed comparator.

10. The spindle motor driving apparatus of claim 9, wherein the rotation speed comparator determines that the detected rotation speed of the spindle motor is not lower than the normal rotation speed if the spindle motor is determined to have reached the normal rotation speed within a predetermined amount of time.
